(19) United States
(12) Patent Application Publication
(10) Pub. No.: US 2002/0122668 A1
(43) Pub. Date: Sep. 5, 2002

(54) Anti-sway camera stabilization device

(76) Inventor: Frank Mattias Tenzer, Capitola, CA (US)

Correspondence Address: Frank Mattias Tenzer, 750 47th Ave. #45, Capitola, CA, 95010, US

(21) Appl. No.: 09/752,211

(22) Filed: Dec. 30, 2000

(51) Int. Cl. G03B 17/00

(52) U.S. Cl. 396/421; 352/243

(57) ABSTRACT

A sway bar arm (10) having on at least one end an attachment (12) (18) for connection to a camera with view screen (24). The arm provides a grasping surface and is effective primarily when angled in a direction counter to the camera's carry handle (16). The photographer grasps the sway bar arm with one hand and the carry handle with the other hand, thereby lessening camera sway. Branches and curvatures of the arm (FIG. 2C (22)) provide clamping surfaces for accessories and grasping surfaces, especially for cameras without carry handles. The arm and its branches can accommodate built in remote camera controls and accessories.

### CROSS-REFERENCE TO RELATED APPLICATIONS

Not applicable.

### BACKGROUND—FIELD OF INVENTION

This invention relates to camera stabilization, specifically to the use of a sway bar which, when grasped by the photographer, helps lessen undesirable sway and shakiness.

### BACKGROUND—DESCRIPTION OF PRIOR ART

Camera stabilization has commonly been achieved in the past using pivoting arms attached to the underside of a camera, which allow the camera to rotate and tilt. In order to keep the camera upright, counterbalance weights had to be attached under the camera. This additional weight made the entire apparatus too heavy to hand hold for extended periods of time. A shoulder mounted device was developed to attach the apparatus to, which could free up the hands. The photographer's legs and back could normally handle the weight better than his or her hands, but they too would strain to hold the weight eventually. U.S. Pat. No. 5,963,749 to Nicholson (1999) is but one such apparatus.

Other camera stabilizers were designed strictly to be attached to the photographer's body and therefore were not at all meant for hand held use. U.S. Pat. No. 5,721,997 to Powell (1998) was one designed primarily for hand held use. This apparatus had a carry handle for one handed carrying and stabilization, which could be tilted and rotated into many useful positions, one of which allowed the camera to hang near the ground as the photographer walked with it. This allowed for an interesting shooting angle, but did not prevent possible sway, not unlike that of a parrot on a birdcage trapeze.

A common hand grip which attaches to the tripod connector of the camera, was designed primarily for accessory attachment and curves around the camera too closely to offer any substantial stabilizing benefit. This grip is not considered a stabilizer and has been manufactured for many decades. A search did not show a patent on this grip.

The previous hand held stabilizers did suffer from certain disadvantages which include:

(a) Limited range of motion due to bulky design and additional weight required.

(b) Higher manufacturing costs due to the amounts of material and labor needed.

(c) Limited portability due to large size.

(d) Limited stability when carried one handed as intended.

(e) Limited time of use due to the amount of added weight.

### SUMMARY

In accordance with the present invention a camera stabilizer consists of a length of rigid material which can be grasped as a handle along any of its curves and branches, and which connects to a camera on at least one of its ends.

Objects and Advantages

Accordingly, other than the objects and advantages of the camera stabilizers described in my patent above, many objects and advantages of the present invention are:

(a) to provide a stabilizer which can be mass produced easily since it consists primarily of a length of rigid material and a camera attachment device.

(b) to provide a stabilizer which is wear resistant since it has few moving parts.

(c) to provide a stabilizer which is simple to use, almost intuitive.

(d) to provide a stabilizer which is lightweight and therefore can be used for longer periods of time than heavier stabilizers.

(e) to provide a stabilizer which can be built to branch off in many directions at once.

(f) to provide a stabilizer which can be sold very cheaply.

(g) to provide a stabilizer which can be used in any grip position including inverted.

(h) to provide a stabilizer which can be used while walking and running.

Further objects and advantages are to provide a stabilizer which can be flexible enough to be bent by hand allowing the photographer to choose his or her own curves and angles, or can be assembled from straight and curved sections connected together anywhere along their lengths to allow for sharp angle adjustments and folding for compact storage, and which can be finished off in a variety of coatings, covers, and colors. Still further objects and advantages should become apparent from the following drawings and related descriptions.

### DRAWING FIGURES

The drawings show related figures having the same number. The alphabetic suffixes refer to some possible variations in that numerical category.

FIGS. 1A to 1C show some of the stabilizers of the type for cameras having common carry handles.

FIGS. 2A to 2C show some of the stabilizers of the type for cameras not having carry handles.

| | | | |
|---|---|---|---|
| 10 | sway bar left hand grip | 12 | accessory shoe connector |
| 14 | accessory shoe | 16 | camera handle right hand grip |
| 18 | camera tripod connector end | 20 | camera tripod connector wing |
| 22 | sway bar right hand grip | | bolt |
| 26 | direction of camera sway | 24 | camera fold out view screen |

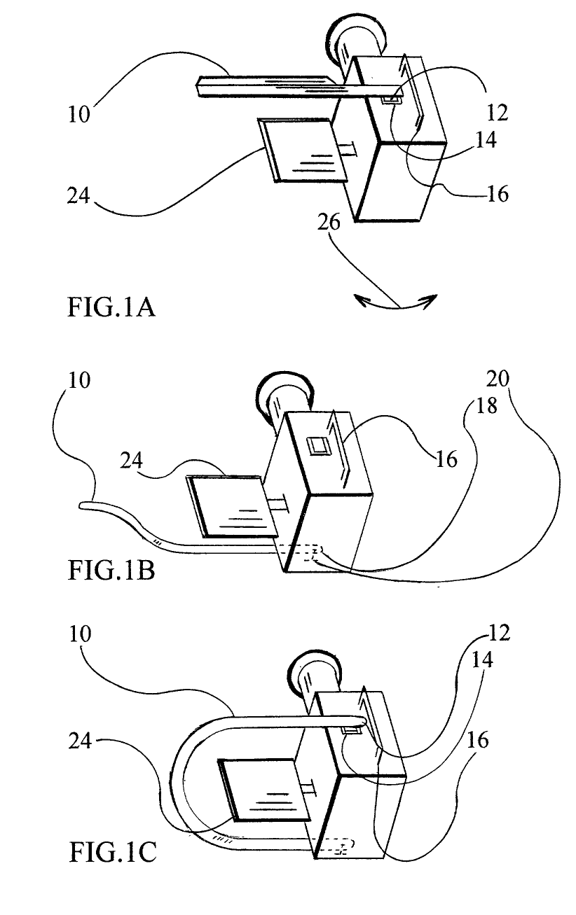

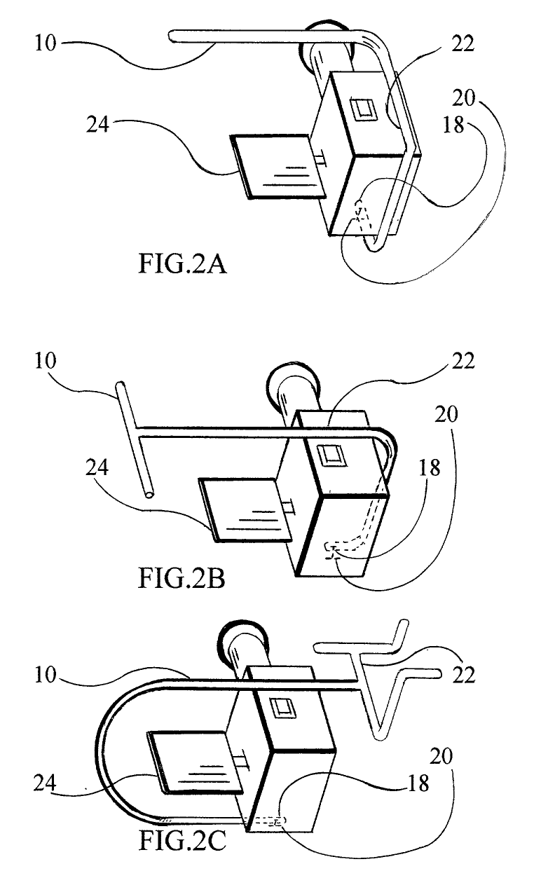

### DESCRIPTION—FIGS 1A and 2A—PREFERRED EMBODIMENT

A preferred embodiment of the stabilizer of the present invention is illustrated in FIG. 1A (attached to a camera with carry handle) and FIG. 2A (attached to a camera without carry handle). The stabilizer in FIG. 1A shows the angle iron shaped handle 10 with the accessory shoe connector 12 attached to the camera's accessory shoe 14, and protruding from the camera at an angle counter to that of the camera's carry handle 16. The amount of side to side sway 26 is lessened substantially when the photographer grasps the sway bar handle 10 in his or her left hand and the camera handle 16 in the right hand, compared to grasping the camera handle alone. The same benefit occurs with the stabilizer in FIG. 1B demonstrating the round or flat sway bar grip 10 which is attached to the bottom of the camera with the tripod connector wing bolt 20 fastened to the tripod connector end 18. The stabilizer in FIG. 1C is connected at the top of the camera as in FIG. 1A as well as the bottom as in FIG. 1B. FIG. 2A shows the basic stabilizer for cameras without carry handles. The right hand grip section 22 has been formed to replace the missing carry handle on the camera. The stabilizer is attached with the camera tripod connector wing bolt 20 to the bottom of the camera. FIG. 2B shows a T shaped bar grip 10 for the left hand, branching from the right hand grip 22. The stabilizer of FIG. 2C branches off in many directions on the right hand grip 22, to accommodate several positions for grasping and accessory attachment.

FIGS. 1A-1C—Additional Embodiments

Additional embodiments are indicated in FIGS. 1A and 1C in that the stabilizers can be removed and reattached protruding to the right instead of the left. The stabilizer of FIG. 1B can protrude out in any direction of 360 degrees, though only certain directions may be useful.

FIGS. 2A-2C—Alternative Embodiments

Various possible grip locations can be created to accommodate cameras without carry handles. The curvature of the sway bar to form a carry handle in FIG. 2A demonstrates a basic stabilizer of this type. FIG. 2B shows a variation T shaped sway bar branch. Sway bars can protrude from cameras at various angles, such as 180 degrees to allow for left hand or right hand operation, and up to 360 degrees for individual angle preferences. The stabilizer in FIG. 2C can protrude from the camera at a broad range of angles.

Advantages

From the description above, certain advantages of my stabilizer become evident:

(a) Since the camera hangs from the stabilizer grips, gravity works with the stabilization rather than against it, and therefore does not require counterweight to regain balance.

(b) Aiming the camera can become more creative with a variety of grip positions for the photographer to grasp.

(c) The amount of material and labor needed to manufacture the stabilizer are minimal due to the simplicity of the sway bar.

(d) Operation of the sway bar requires minimal instruction due to its simplicity.

(e) A tripod quick release plate can be attached to the bottom of the stabilizer near the tripod connector, to allow for easy attachment to a tripod.

(f) For cameras without carry handles, the sway bar makes for a convenient grab-and- go type of grip to carry the camera with.

Operation—FIGS. 1 and 2

The manner in which the stabilizer is operated in FIG. 1 is the same as when carrying the camera with the right hand on the carry handle 16, the left hand then grasps the sway bar 10 to lessen the sway 26. For overhead shots, the right hand thumb can be inserted under the carry handle 16, the camera lifted above the photographer's head, the view screen 24 tilted downward to help frame the shot, and the left hand then grasping the sway bar 10 to help stabilize and aim the camera.

Camera operation in FIG. 2 is similar to FIG. 1. In FIG. 2A, the overhead shot can be accomplished with greater comfort by grasping the right hand grip 22 lower to the rear of the camera near the bottom. The left hand on the sway bar 10 should still be able to significantly stabilize this top heavy maneuver.

The carry grip 22 in FIG. 2A can be made to fit so closely to the camera body that it will allow for the photographer's fingers to reach pertinent camera controls. Camera remote controls can also be attached to or built into the sway bar along with accessories.

Conclusion, Ramifications, and Scope

The stabilizer can be used with a multitude of cameras and camcorders. It offers design flexibility to fit numerous brands and models. Camera attachment can be accomplished in various ways and directions. Additional advantages include

less weight, including the lack of counter weight, to allow the photographer to shoot hand held for longer periods of time with less fatigue.

lower cost, less material and labor, and simpler construction than other stabilizing devices presently on the market.

simpler operation since the use of the stabilizer is almost intuitive.

reliable and wear resistant since it has few moving parts.

flexibility since it can be constructed of solid materials or rigid materials that can allow for some bending by the photographer for custom shaping.

variety of gripping positions because of the branching and curving that can be incorporated into the sway bar.

Although specific details have been described above, they are meant for demonstration and not for limiting the scope of this invention. For example, the rigid materials of which the stabilizer can be constructed should include, but not be limited to metal, plastic, wood, etc. The shape should include, but not be limited to round, square, flat, hollow, solid, etc. It should curve and branch out in any direction. It should include, but not be limited to curves on the branches, and branches on the branches, etc.

Therefore the scope of this stabilizer should be determined by the appended claims and their legal equivalents, instead of the given examples.

I claim:

1. A hand-held camera sway bar stabilizer of the type comprising an elongated means attached to a camera, which decreases camera sway when grasped, thereby increasing camera stabilization, and a fastening device on at least one end to connect said elongated means to said camera.

2. The stabilizer of claim 1 wherein said elongated means has a curvature to allow for a multitude of hand gripping angles.

3. The stabilizer of claim 1 wherein said elongated means branches off to allow for a multitude of hand gripping angles.

4. The stabilizer of claim 3 wherein branching off of said elongated means has a curvature to allow for an even greater multitude of gripping angles.

5. The stabilizer of claim 1 wherein said elongated means is composed of a rigid material.

6. The stabilizer of claim 5 wherein said rigid material can be forcibly bent or curved by the photographer to the desired angle.

7. The stabilizer of claim 5 wherein sections of said rigid material are connected together to allow for a multitude of angles, and folding or disassembly for storage.

8. The stabilizer of claim 5 wherein said rigid material is shaped flat or like angle iron.

9. The stabilizer of claim 5 wherein said rigid material is shaped rounded and hollow when viewed in the cross section.

10. The stabilizer of claim 5 wherein said rigid material is shaped rounded and solid when viewed in the cross section.

11. The stabilizer of claim 5 wherein said rigid material is molded, such as a plastic mold.

12. A camera stabilizer of the type comprising an elongated means attached to a hand- held camera and a fastening device on at least one end to connect said elongated means to said camera.

13. The stabilizer of claim 12 wherein said elongated means has a curvature to allow for a multitude of hand gripping angles.

14. The stabilizer of claim 12 wherein said elongated means branches off to allow for a multitude of hand gripping angles.

15. The stabilizer of claim 14 wherein branching off of said elongated means has a curvature to allow for an even greater multitude of gripping angles.

16. The stabilizer of claim 12 wherein said elongated means is composed of a rigid material.

17. The stabilizer of claim 16 wherein said rigid material can be forcibly bent or curved by the photographer to the desired angle.

18. The stabilizer of claim 16 wherein said rigid material is molded, such as a plastic mold.
